(19) United States
(12) Patent Application Publication
(10) Pub. No.: US 2023/0406328 A1
(43) Pub. Date: Dec. 21, 2023

(54) CONTROL DEVICE FOR VEHICLE AND CONTROL METHOD THEREFOR

(71) Applicant: HYUNDAI MOBIS CO., LTD., Seoul (KR)

(72) Inventor: Byung Chul PARK, Yongin-si (KR)

(73) Assignee: HYUNDAI MOBIS CO., LTD., Seoul (KR)

(21) Appl. No.: 18/081,085

(22) Filed: Dec. 14, 2022

(30) Foreign Application Priority Data
May 19, 2022 (KR) 10-2022-0061358

(51) Int. Cl. B60W 50/00; B60W 10/188

(52) U.S. Cl. CPC B60W 50/0098; B60W 2520/28; B60W 2050/0056; B60W 10/188

(57) ABSTRACT

A control device for a vehicle includes a sensor unit detecting wheel acceleration based on a wheel speed of a wheel of the vehicle; a filter unit generating a wheel acceleration graph using the wheel acceleration detected by the sensor unit; a storage unit updating and storing a reference point of the wheel acceleration on the wheel acceleration graph; a slope calculation unit calculating a slope of the wheel acceleration based on the reference point on the wheel acceleration graph; and a determination unit determining whether a jerk occurred in the vehicle using a change amount of the reference point and the slope of the wheel acceleration.

### CROSS-REFERENCE TO RELATED APPLICATIONS

The present application is based on and claims the benefit of priority to Korean Patent Application Number 10-2022-0061358, filed on May 19, 2022 in the Korean Intellectual Property Office, the entire disclosure of which is incorporated herein by reference.

### TECHNICAL FIELD

The present disclosure relates to control device for vehicle and control method therefor.

### BACKGROUND

The content described in the present section merely provides background information on the present disclosure and does not constitute the prior art.

A vehicle may implement a remote smart parking assist (RSPA) function using cooperative control of various controllers such as a drive controller, a shift controller, and a brake controller. In the RSPA function, the target vehicle speed control of the vehicle may be implemented mainly using braking control. An electric brake may follow the target pressure of each wheel by driving a motor to increase the pressure of each wheel and maintaining and reducing the pressure of the wheel using a solenoid valve such as a Traction Control Valve (TCV).

For the RSPA function, it is important to control each wheel so that the vehicle precisely follows the target vehicle speed for the purpose of safety and accident prevention. When the target vehicle speed of the vehicle is controlled using the TCV and the motor of the electric brake, the motor may be excessively driven due to problems such as tuning, or hydraulic pressure may be excessively released from the TCV due to insufficient current. When the above-described problem occurs, there is a problem in that it is difficult to precisely follow the target vehicle speed of the vehicle for the RSPA function.

Furthermore, when a ball for opening or closing the TCV is not properly seated, the ball may be displaced and the hydraulic pressure may be excessively released from the TCV. When the hydraulic pressure is released from the TCV, oscillation of the speed and acceleration of the vehicle occurs, causing vibration in the vehicle and reducing riding comfort.

### SUMMARY

An embodiment of the present disclosure provides a control device for a vehicle comprising: a sensor unit detecting wheel acceleration based on a wheel speed of a wheel of the vehicle; a filter unit generating a wheel acceleration graph using the wheel acceleration detected by the sensor unit; a storage unit updating and storing a reference point of the wheel acceleration on the wheel acceleration graph; a slope calculation unit calculating a slope of the wheel acceleration based on the reference point on the wheel acceleration graph; and a determination unit determining whether a jerk occurred in the vehicle using a change amount of the reference point and the slope of the wheel acceleration.

An embodiment of the present disclosure provides a method of controlling a control device for a vehicle comprising: a detection step of detecting wheel acceleration based on a wheel speed of a wheel of the vehicle; a generation step of generating a wheel acceleration graph using the wheel acceleration; a storage step of updating and storing a reference point of the wheel acceleration on the wheel acceleration graph; a slope calculation step of calculating a slope of the wheel acceleration based on the reference point on the wheel acceleration graph; and a determination step of determining whether a jerk occurred in the vehicle using a change amount of the reference point and the slope of the wheel acceleration.

### BRIEF DESCRIPTION OF THE DRAWINGS

FIG. 1 is a graph showing the occurrence of oscillation of wheel acceleration due to a drop in hydraulic pressure in a conventional control device for a vehicle.

FIG. 2 is a diagram showing the configuration of a control device for a vehicle according to an embodiment of the present disclosure.

FIG. 3 is a wheel acceleration graph generated by a filter unit of the control device for the vehicle according to an embodiment of the present disclosure.

FIG. 4 is a graph showing a signal of the control device for the vehicle according to an embodiment of the present disclosure.

FIG. 5 is a flowchart showing a control method for a control device for a vehicle according to an embodiment of the present disclosure.

### DETAILED DESCRIPTION

The present disclosure provides a control device for a vehicle which can detect the excessive driving of a motor and the release of hydraulic pressure from from a TCV.

A control device for a vehicle according to an embodiment can detect and prevent the displacement of a ball from a TCV.

The problems to be solved by the present disclosure are not limited to the abovementioned problems, and other problems which are not mentioned will be clearly understood by those skilled in the art from the following description.

Hereinafter, some exemplary embodiments of the present disclosure will be described in detail with reference to the accompanying drawings. In the following description, like reference numerals preferably designate like elements, although the elements are shown in different drawings. Furthermore, in the following description of various exemplary embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout the present specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

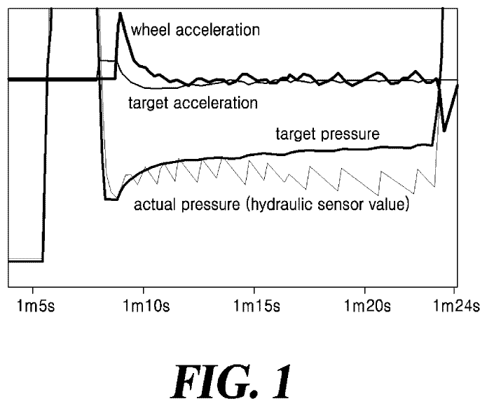

FIG. 1 is a graph showing the occurrence of oscillation of wheel acceleration due to a drop in hydraulic pressure in a conventional control device for a vehicle.

The conventional control device for the vehicle controls the target vehicle speed of the vehicle using a TCV and a motor of an electric brake. Here, the motor may be excessively driven due to a problem such as tuning, or hydraulic pressure may be excessively released from the TCV due to insufficient current. Furthermore, when a ball for opening or closing the TCV is not properly seated, the ball may be displaced and the hydraulic pressure may be excessively released from the TCV. When the hydraulic pressure is released from the TCV, oscillation occurs in the speed and acceleration of the vehicle, thereby causing vibration in the vehicle and reducing riding comfort.

Referring to FIG. 1, it can be seen that when the target pressure of each wheel is being increased but the hydraulic pressure is released from the TCV due to the above-described problem of the TCV, oscillation occurs in wheel acceleration. When compared with the target acceleration, it can be seen that the oscillation occurs in the wheel acceleration. That is, the vehicle may wobble due to the oscillation in the wheel acceleration, and consequently, riding comfort may be deteriorated.

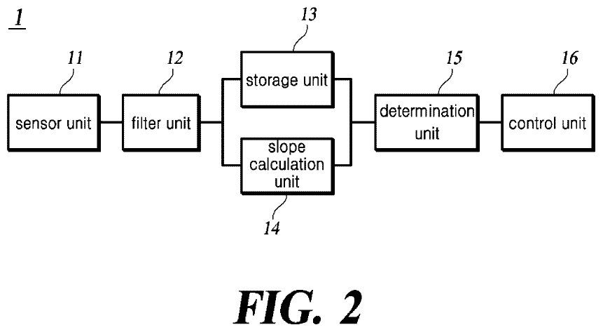

FIG. 2 is a diagram showing the configuration of a control device for a vehicle according to an embodiment of the present disclosure.

Referring to FIG. 2, the control device 1 for the vehicle according to an embodiment of the present disclosure may include all or some of a sensor unit 11, a filter unit 12, a storage unit 13, a slope calculation unit 14, a determination unit 15, and a control unit 16.

According to an exemplary embodiment of the present disclosure, the control device 1 may include a processor (e.g., computer, microprocessor, CPU, ASIC, circuitry, logic circuits, etc.) and an associated non-transitory memory storing software instructions which, when executed by the processor, provides the functionalities of the sensor unit 11, the filter unit 12, the slope calculation unit 14, the determination unit 15, and the control unit 16. Herein, the memory and the processor may be implemented as separate semiconductor circuits. Alternatively, the memory and the processor may be implemented as a single integrated semiconductor circuit. The processor may embody one or more processor(s).

The sensor unit 11 may detect the wheel speed of each wheel using a wheel speed sensor. The sensor unit 11 may detect the wheel acceleration using the wheel speed detected by the wheel speed sensor. That is, the sensor unit 11 may calculate the wheel acceleration by differentiating the wheel speed.

The filter unit 12 may generate a wheel acceleration graph using the wheel acceleration detected by the sensor unit 11. The filter unit 12 may use a low-pass filter to generate a wheel acceleration graph in which noise is reduced. In this case, the wheel acceleration graph generated by the filter unit 12 may not be a continuous graph but may be a discrete graph. The filter unit 12 may generate a wheel acceleration graph using the wheel acceleration which is discretely measured at a predetermined time interval. For example, the filter unit 12 may generate the wheel acceleration graph using the wheel acceleration measured at the interval of seconds. However, for the convenience of description, the wheel acceleration graph in the drawing may be expressed as a continuous graph.

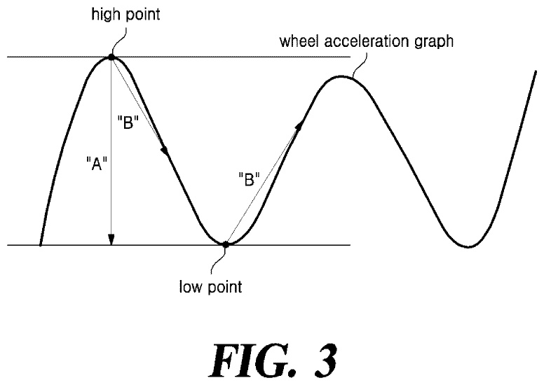

The storage unit 13 may update and store a reference point on the wheel acceleration graph generated by the filter unit 12. In this case, the reference point refers to a point at which the abovementioned wheel acceleration measured at the predetermined time interval (e.g. 0.02 sec) becomes a high point or a low point. The high point refers to a point where the measured wheel acceleration is greater than wheel acceleration measured immediately before or after the point, while the low point refers to a point where the measured wheel acceleration is smaller than wheel acceleration measured immediately before or after the point. For example, the high point and/or the low point refer to a vertex on the wheel acceleration graph of FIG. 3.

The storage unit 13 stores the reference point, and may update and store a new reference point if the new reference point is generated. For example, when the high point is the reference point and thereafter the low point is generated, the low point may be updated and stored as the reference point. The storage unit 13 may be a hardware (e.g. a memory) or a combination of hardware and software.

The slope calculation unit 14 may calculate the slope of the wheel acceleration. The slope of the wheel acceleration refers to a slope from the reference point on the wheel acceleration graph to the current wheel acceleration. In this case, the current wheel acceleration refers to a wheel acceleration value at the time of calculating the slope in the wheel acceleration which is discretely measured based on the above-described predetermined time interval. For example, when the wheel acceleration is measured at the interval of 0.02 seconds, the slope calculation unit 14 may calculate the new slope of wheel acceleration at the interval of 0.02 seconds using the wheel acceleration measured at the interval of 0.02 seconds.

Since the slope calculation unit 14 performs calculation based on the reference point, the slope of the wheel acceleration may have a positive value or a negative value. The slope of the wheel acceleration calculated by the slope calculation unit 14 may have the positive value or the negative value depending on the reference point stored in the storage unit 13. For example, when the reference point is the high point, the slope of the wheel acceleration calculated by the slope calculation unit 14 may have a negative value, but when the reference point is the low point, the slope of the wheel acceleration calculated by the slope calculation unit 14 may have a positive value (see FIG. 3).

The determination unit 15 may determine whether a jerk occurred in the vehicle using the reference point stored by the storage unit 13 and the slope of the wheel acceleration calculated by the slope calculation unit 14. The jerk is a derivative of acceleration, and is a number which is directly related to riding comfort. However, herein, the expression “the jerk occurred” means that the derivative of the acceleration satisfying a specific condition is measured. The process of determining whether the jerk occurred will be described below in detail.

In response to a determination that the jerk has occurred in the vehicle, the control unit 16 may control the control device 1 for the vehicle to reduce the jerk. The control unit 16 may control the Traction Control Valve (TCV) and the motor of the control device 1 for the vehicle. The control unit 16 may reduce the jerk by controlling the motor and the TCV to decrease, increase or maintain the braking control amount of the vehicle.

For example, the control unit 16 may maintain the braking control amount of the vehicle by increasing a parameter value which is proportional to the amount of current applied to the TCV. The control unit 16 may increase the ball pushing force of the TCV by temporarily increasing the amount of current of the TCV in a predetermined pressure section, thereby maintaining the hydraulic pressure of the wheel. For example, if the amount of current of the TCV is controlled to be 0.5 A in a state where the target wheel pressure is 10 bar at normal times, the amount of current of the TCV may be controlled to be 0.8 A in a state where the target wheel pressure is 10 bar in a jerk situation. However, since the amount of current of the TCV is set with reference to the target wheel pressure of the vehicle, the amount of current of the TCV may be changed when the target wheel pressure is changed (the amount of current may be temporarily increased, but may be reduced again due to a reduction in target wheel pressure). Therefore, the target wheel pressure is maintained until the jerk reduction control of the control device 1 for the vehicle is finished.

Furthermore, as a complement to the above-described method, the control unit 16 may increase the target wheel pressure of the control device 1 for the vehicle. The control unit 16 may increase the target wheel pressure by driving the motor. As the target wheel pressure increases, the parameter value of the current of the TCV may be increased. Thus, the amount of current of the TCV may be increased, and the ball pushing force of the TCV may be increased to maintain the hydraulic pressure of the wheel.

FIG. 3 is a wheel acceleration graph generated by the filter unit of the control device for the vehicle according to an embodiment of the present disclosure.

Referring to FIG. 3, the filter unit 12 of the control device 1 for the vehicle according to the present disclosure may generate the wheel acceleration graph. The filter unit 12 may generate the wheel acceleration detected by the sensor unit 11 as the wheel acceleration graph in which noise is reduced using the low-pass filter. The filter unit 12 may generate the wheel acceleration graph using the wheel acceleration which is discretely measured at a predetermined time interval. For example, the filter unit 12 may generate the wheel acceleration graph using the wheel acceleration measured at the interval of 0.02 seconds.

As described above, the high point and the low point may become the reference point at which the control device 1 for the vehicle according to the present disclosure calculates the slope of the wheel acceleration. The high point refers to a point where the measured wheel acceleration is greater than wheel acceleration measured immediately before or after the point, while the low point refers to a point where the measured wheel acceleration is smaller than wheel acceleration measured immediately before or after the point.

FIG. 3 is a part of the wheel acceleration graph, and the wheel acceleration graph may be continuously generated as the vehicle is driven, and the high point and the low point may be continuously updated. Reference character A denotes the amount of change in wheel acceleration between the high point and the low point. Reference character B denotes a slope from the high point or the low point to the current wheel acceleration. That is, the slope calculation unit 14 may calculate the slope B of the wheel acceleration. Since the wheel acceleration is measured at a predetermined time interval, the slope B of the wheel acceleration may change at a predetermined time interval.

The determination unit 15 may determine whether the jerk of the vehicle occurred, using the change amount A of the wheel acceleration between the high point and the low point and the slope B of the wheel acceleration.

As the vehicle is continuously driven, the high point and the low point may be continuously updated. When the change amount A of the wheel acceleration between the high point and the low point which are continuously updated falls within a preset range, the determination unit 15 may determine that a first condition is satisfied. For example, when the absolute value of the change amount A of the wheel acceleration between the high point and the low point is 0.05 or more and 0.15 or less, the determination unit 15 may determine that the first condition is satisfied.

When the absolute value of the slope B of the wheel acceleration is equal to or more than a preset slope, the determination unit 15 may determine that the second condition is satisfied. For example, when the absolute value of the slope B of the wheel acceleration is or more, the determination unit 15 may determine that the second condition is satisfied.

When during a preset time the first condition is satisfied a preset number of times and the second condition is satisfied, the determination unit 15 may determine that the jerk occurred in the vehicle. For example, when the first condition is satisfied four times and the second condition is satisfied during 2 seconds, the determination unit 15 may determine that the jerk occurred in the vehicle.

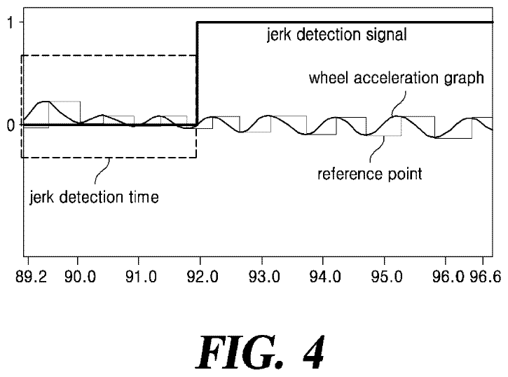

FIG. 4 is a graph showing a signal of the control device for the vehicle according to an embodiment of the present disclosure.

Referring to FIG. 4, the filter unit 12 of the present disclosure may continuously update the high point and the low point, and may generate the wheel acceleration graph. The storage unit 13 may store the high point or the low point. Referring to the reference-point line of FIG. 4, it can be seen that the storage unit 13 stores the high point (or the low point) and thereafter stores a new low point (or high point) if the new low point (or high point) is updated. The slope calculation unit 14 may calculate the slope of the wheel acceleration with reference to the high point or low point stored in the storage unit 13.

The determination unit 15 may determine whether the first condition and the second condition are satisfied during a jerk detection time. As described above, when the first condition is satisfied a predetermined number of times and the second condition is satisfied during the jerk detection time, the determination unit 15 may determine that the jerk occurred in the vehicle. When the determination unit 15 determines that the jerk occurred in the vehicle, the determination unit 15 may transmit a jerk detection signal to the control unit 16, and the control device 1 for the vehicle may control to reduce the jerk.

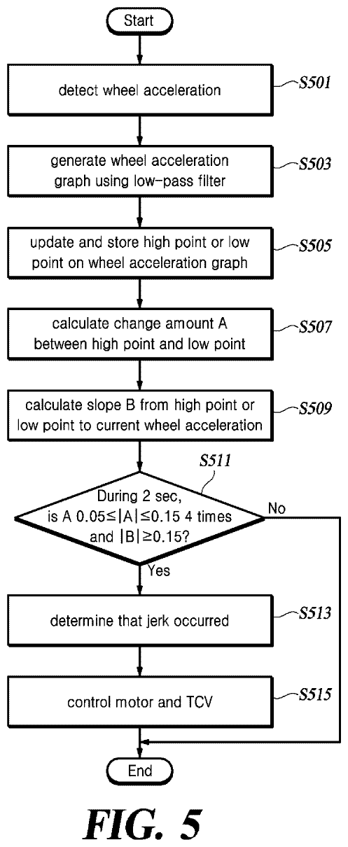

FIG. 5 is a flowchart showing a control method for a control device for a vehicle according to an embodiment of the present disclosure.

Referring to FIG. 5, the sensor unit 11 may detect the wheel acceleration (S501). The sensor unit 11 may detect the wheel acceleration using the wheel speed which is detected by the wheel speed sensor. That is, the sensor unit 11 may calculate the wheel acceleration by differentiating the wheel speed.

The filter unit 12 may generate the wheel acceleration detected by the sensor unit 11 as the wheel acceleration graph in which noise is reduced using the low-pass filter (S503). In this case, the wheel acceleration graph generated by the filter unit 12 may not be a continuous graph but may be a discrete graph. The filter unit 12 may generate the wheel acceleration graph using the wheel acceleration which is discretely measured at a predetermined time interval.

The storage unit 13 may update and store a high point or a low point on the wheel acceleration graph generated by the filter unit 12 (S505). The high point refers to a point where the measured wheel acceleration is greater than wheel acceleration measured immediately before or after the point, while the low point refers to a point where the measured wheel acceleration is smaller than wheel acceleration measured immediately before or after the point.

The determination unit 15 may calculate the change amount A of the wheel acceleration between the high point and the low point on the wheel acceleration graph (S507). The slope calculation unit 14 may calculate the slope of the wheel acceleration (S509). The slope of the wheel acceleration refers to a slope from the reference point on the wheel acceleration graph to the current wheel acceleration.

The determination unit 15 may determine whether the jerk of the vehicle occurred, using the change amount A of the wheel acceleration between the high point and the low point and the slope B of the wheel acceleration (S511). When the change amount A of the wheel acceleration between the high point and the low point falls within a preset range, the determination unit 15 may determine that a first condition is satisfied. For example, when the absolute value of the change amount A of the wheel acceleration between the high point and the low point is 0.05 or more and 0.15 or less, the determination unit 15 may determine that the first condition is satisfied.

When the absolute value of the slope B of the wheel acceleration is equal to or more than a preset slope, the determination unit 15 may determine that the second condition is satisfied. For example, when the absolute value of the slope B of the wheel acceleration is or more, the determination unit 15 may determine that the second condition is satisfied.

During a preset time, when the first condition is satisfied a preset number of times and the second condition is satisfied, the determination unit 15 may determine that the jerk occurred in the vehicle. For example, when the first condition is satisfied four times during 2 seconds and the second condition is satisfied, the determination unit 15 may determine that the jerk occurred in the vehicle (S513).

In response to a determination that the jerk occurred in the vehicle, the control unit 16 may control the control device 1 for the vehicle to reduce the jerk (S515). The control unit 16 may control the TCV and the motor of the control device 1 for the vehicle. The control unit 16 may reduce the jerk by controlling the motor and the TCV to decrease, increase or maintain the braking control amount of the vehicle.

According to an embodiment, a control device for a vehicle is advantageous in that a RSPA function can be controlled with a target vehicle speed by detecting the excessive driving of a motor and the release of hydraulic pressure from a TCV and changing a control method.

According to an embodiment, a control device for a vehicle is advantageous in that the vibration of the vehicle can be reduced by preventing a ball from being displaced from a TCV.

Each component of the apparatus or method according to the present disclosure may be implemented as hardware or software, or a combination of hardware and software. Further, the function of each component may be implemented as software and a microprocessor may be implemented to execute the function of software corresponding to each component.

Various implementations of systems and techniques described herein may be realized as digital electronic circuits, integrated circuits, field programmable gate arrays (FPGAs), application specific integrated circuits (ASICs), computer hardware, firmware, software, and/or combinations thereof. These various implementations may include one or more computer programs executable on a programmable system. The programmable system includes at least one programmable processor (which may be a special-purpose processor or a general-purpose processor) coupled to receive and transmit data and instructions from and to a storage system, at least one input device, and at least one output device. The computer programs (also known as programs, software, software applications or codes) contain commands for a programmable processor and are stored in a “computer-readable recording medium”.

The computer-readable recording medium includes all types of recording devices in which data readable by a computer system is stored. Such a computer-readable recording medium may be a non-volatile or non-transitory medium, such as ROM, CD-ROM, magnetic tape, floppy disk, memory card, hard disk, magneto-optical disk, or a storage device, and may further include a transitory medium such as a data transmission medium. In addition, the computer-readable recording medium may be distributed in a computer system connected via a network, so that computer-readable codes may be stored and executed in a distributed manner.

The flowchart/timing diagram of the present specification describes that processes are sequentially executed, but this is merely illustrative of the technical idea of an embodiment of the present disclosure. In other words, since it is apparent to those skilled in the art that an order described in the flowchart/timing diagram may be changed or one or more processes may be executed in parallel without departing from the essential characteristics of an embodiment of the present disclosure, the flowchart/timing diagram is not limited to a time-series order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A control device for a vehicle comprising:
a sensor unit detecting wheel acceleration based on a wheel speed of a wheel of the vehicle;
a filter unit generating a wheel acceleration graph using the wheel acceleration detected by the sensor unit;
a storage unit updating and storing a reference point of the wheel acceleration on the wheel acceleration graph;
a slope calculation unit calculating a slope of the wheel acceleration based on the reference point on the wheel acceleration graph; and
a determination unit determining whether a jerk occurred in the vehicle using a change amount of the reference point and the slope of the wheel acceleration.

2. The control device of claim 1, wherein the filter unit uses a low-pass filter.

3. The control device of claim 1, wherein the filter unit generates the wheel acceleration graph using a wheel acceleration which is discretely measured at a predetermined time interval.

4. The control device of claim 3, wherein the reference point is a point at which the wheel acceleration measured at the predetermined time interval becomes a high point or a low point.

5. The control device of claim 4, wherein the storage unit updates either the high point or the low point as the reference point.

6. The control device of claim 4, wherein the determination unit determines whether an absolute value of the change amount of the wheel acceleration between the high point and the low point satisfies a first condition, and whether an absolute value of the slope satisfies a second condition.

7. The control device of claim 6, wherein, when the first condition is satisfied a preset number of times during a preset time and the second condition is satisfied, the determination unit determines that the jerk occurred.

8. The control device of claim 1, further comprising:
in response to a determination that the jerk occurred, a control unit controlling a Traction Control Valve (TCV) and a motor of the control device for the vehicle.

9. The control device of claim 8, wherein the control unit applies additional current to the TCV, when the determination unit determines that the jerk occurred in the vehicle.

10. A method of controlling a control device for a vehicle comprising:
a detection step of detecting wheel acceleration based on a wheel speed of a wheel of the vehicle;
a generation step of generating a wheel acceleration graph using the wheel acceleration;
a storage step of updating and storing a reference point of the wheel acceleration on the wheel acceleration graph;
a slope calculation step of calculating a slope of the wheel acceleration based on the reference point on the wheel acceleration graph; and
a determination step of determining whether a jerk occurred in the vehicle using a change amount of the reference point and the slope of the wheel acceleration.

11. The method of claim 10, wherein the detection step calculates the wheel acceleration by differentiating the wheel speed detected by a wheel speed sensor.

12. The method of claim 10, wherein the generation step generates the wheel acceleration graph using a wheel acceleration which is discretely measured at a predetermined time interval.

13. The method of claim 12, wherein the storage step updates and stores a point at which the wheel acceleration measured at the predetermined time interval becomes a high point or a low point.

14. The method of claim 13, wherein the storage step updates either the high point or the low point as the reference point.

15. The method of claim 13, wherein the determination step comprises:
determining whether an absolute value of the change amount of the wheel acceleration between the high point and the low point satisfies a first condition; and
determining whether an absolute value of the slope satisfies a second condition.

16. The method of claim 15, wherein, when, during a preset time, the first condition is satisfied a preset number of times and the second condition is satisfied, the determination step determines that the jerk occurred.

17. The method of claim 10, further comprising:
in response to a determination that the jerk occurred, a control step controlling a TCV and a motor of the control device for the vehicle.
